(19) United States
(12) Patent Application Publication
(10) Pub. No.: US 2002/0117831 A1
(43) Pub. Date: Aug. 29, 2002

(54) Hitch coupling aid

(76) Inventors: Donald B. Ahlquist, Gull Lake (CA); Terry Williamson, Thorsby (CA); Daniel M. Ahlquist, Gull Lake (CA)

Correspondence Address: Sean W. Goodwin, Goodwin Berlin McKay, The Burns Building, Suite 660, 237 - 8th Avenue S.E., Calgary, AB, T2G 5C3, CA

(21) Appl. No.: 09/902,717

(22) Filed: Jul. 12, 2001

(30) Foreign Application Priority Data
Jul. 12, 2000 (CA) 2,313,748

(51) Int. Cl. B62D 53/06; B60D 1/00

(52) U.S. Cl. 280/477; 280/425.1

(57) ABSTRACT

A hitch sling for aiding in coupling a trailer's socket to a ball mounted on a tongue extending from a tow vehicle comprises: a leg secured to the trailer and having a first roller located at lower end of the leg and below the trailer's socket, a winch, and a flexible line which extends from the winch, about the first roller and to a distal end, so that, when the distal end is secured to the tongue and the line shortened, the leg is lifted upwardly towards the tongue so as to position the socket substantially above the ball, and when the line is lengthened, the socket is lowered onto the ball for coupling. Preferably a second roller is positioned between the winch and first roller so as to direct the line along or through the leg to the winch.

### FIELD OF THE INVENTION

This invention relates to accessories for assisting in the coupling of towed vehicles with a hitch on a tow vehicle. More particularly, apparatus is provided for lifting and supporting a trailer tongue and guiding it onto a ball or the like supported by the hitch.

### BACKGROUND OF THE INVENTION

A towed vehicle or trailer has a forward extending yoke or frame, at the end of which is a first coupling means. The towing vehicle has a complementary second coupling means. Typically, these first and second coupling means are a tongue with a socket, and a ball, respectively. Another well known configuration includes an eye and a hook respectively.

In each instance, the trailer's yoke must be lifted for decoupling and coupling. In the simplest case, the operator lifts the yoke and manhandles the trailer socket over the ball, manipulating the socket left and right until they are aligned vertically, and then lowering the socket onto the ball.

As trailer tongue weight increases, this strong-arm approach becomes more difficult, more hazardous, and can eventually can be beyond the lifting capability of an operator. Tongue weight is related to the towing capacity which is known by basic classes: a Class I has a maximum rated towing capacity of 2,000 lbs. with a tongue weight of about 200 lbs.; and the most common tow hitch for utility vehicles is a Class III having a maximum rated capacity of 3,500 lbs.-5,000 lbs. with a tongue weight of 500-750 lbs. Tongue weight can be extended upwards to 1200 lbs.

At these higher levels, manhandling of the trailer's tongue is no longer feasible. Other mechanically assisted approaches include use of a jack at the tongue to elevate the tongue. The tow vehicle's ball must then be maneuvered underneath the socket. Despite the seemingly simple nature of this approach, the operator is guiding only by instinct and skill and the operation preferably involves two persons. Further, repeated attempts to reach optimum alignment for hitching is frustrating for the tow vehicle operator and, invariably, the tongue ends up being rammed by the tow vehicle.

Prior art apparatus is known to aid in coupling ball and socket type couplings. In U.S. Pat. No. 3,596,925 to Richie, a winch is provided and a winch cable and cable loop extend from the trailer. The cable is passed around a corresponding cable pulley, installed at the towing vehicle, in the horizontal plane below the ball, and returns for connection to the trailer. The cable is guided through a tube beneath the tongue and socket so that as the cable is shortened, the tongue and ball approach and the positioning of guide tube and pulley positions the socket over the ball. This system not designed to elevate heavy trailer tongues, the pulley being designed for a lateral movement—not a lifting action. Lifting loads result in sharp angles of engagement between the cable and pulley, subjecting high stresses and damage to the cable, guide tube and pulley.

In U.S. Pat. No. 5,938,227 to Hills, a winch cable driven system is used which avoids cable damage by modifying both the ball and the socket. A cable is passed upwardly through a hole formed through the ball and terminates inside the socket. The cable rides over a small pulley installed in the ball, located within its spherical profile. When the cable is winched from the tow vehicle, the trailer's socket are drawn to the ball. The cable lifts and finally draws the socket onto the ball. This system is complex and requires significant modifications to known couplings; requiring a custom ball and tongue to accommodate the cable, and it interferes with the integrity of both the ball and the socket.

### SUMMARY OF THE INVENTION

The hitch sling alleviates the inherent problems in securing a trailer to a towing vehicle. The preferred embodiment of the hitch sling provides a safe and secure three-axis control (up-down, left-right, forward-back) of a trailer's coupling socket while aligning, elevating and finally lowering the trailer's socket over a towing vehicle's coupling ball. The hitch sling can also serve as a jack stand (or dolly) for leveling and parking a trailer or towed implement.

The hitch sling basically comprises a leg with a first roller at the leg's lower end. A winch is secured to the trailer's tongue or leg, fixing the winch relative to the first roller. The hitch sling is secured to the trailer adjacent the tongue so that the first roller is located below the tongue and thus is located below the socket. Accordingly, when the winch pulls the line, the line pulls around the first roller and shortens. If the line's distal end is secured to the towing vehicle's hitch, the roller is drawn upwardly towards the hitch and thus permits the tongue's socket to be aligned with the ball.

In a broad aspect of the invention, apparatus is provided for aiding in coupling a trailer's socket to a ball mounted on a tongue extending from a tow vehicle, the coupling aid comprising: a leg secured to the trailer and having a lower end located below the trailer's socket; a first roller at the leg's lower end and positioned substantially below the trailer's socket; a winch; and a flexible line which extends from the winch, about the first roller and to a distal end, so that, when the distal end is secured to the tongue and the line shortened, the leg is lifted upwardly towards the tongue so as to position the socket substantially above the ball, and when the line is lengthened, the socket is lowered onto the ball for coupling.

### BRIEF DESCRIPTION OF THE DRAWINGS

FIG. 1 is an isometric view of a trailer tongue coupled with a hitch ball of a towing vehicle. A hitch coupling apparatus according to a first embodiment of the present invention is illustrated;

FIG. 2a is a side view of the apparatus of FIG. 1 illustrated as being used as a jack or stand with the leg being winched downwardly;

FIG. 2b is a top view of the apparatus of FIG. 2a, illustrated in preparation for winching up to the ball;

FIG. 3a illustrates the apparatus of FIG. 2a where the tongue is winched above the ball;

FIG. 3b illustrates the apparatus of FIG. 3a where the tongue is set onto the ball and the cable is left on as an additional safety restraint;

FIG. 4 illustrates the apparatus of FIG. 3a where the tongue is set onto the ball;

FIGS. 5a-5c illustrate a number of alternate sling ends for hooking to the hitch and ball; a slip joint, a fixed loop and a hook;

FIG. 6 is a side view of the apparatus of FIG. 1 used as a jack or stand and illustrated in preparation for winching up to the ball;

FIG. 7 illustrates the apparatus of FIG. 6 where the coupling apparatus is raised up for providing roading clearance;

FIG. 8a illustrates the apparatus of FIG. 2b where the tongue is winched above the ball and is being rotated over the ball;

FIG. 8b is a cross section of the pin and slot according to section VIIIb-VIIIb of FIG. 3a;

FIG. 9a is a side view of an alternate embodiment of the coupling apparatus where the tongue is winched above the ball;

FIG. 9b illustrates the apparatus of FIG. 9a where the cable has been released somewhat to seat the tongue on the ball. Further, the jack stand posts have been raised for road travel;

FIG. 10a is a front isometric view of the apparatus of FIG. 9a;

FIG. 10b is a front isometric view of the apparatus of FIG. 9b;

FIG. 11a and 11b are a side views according to FIG. 9a wherein the trailer and ball are not longitudinally aligned and rotation of the apparatus effects the alignment;

FIG. 12a and 12b are side views according to FIGS. 9a and 9b respectively and are illustrative of the various clearances and geometry;

FIG. 13 is a side view of yet another alternate embodiment of the coupling apparatus which utilizes a single rotatable jack stand, shown in the coupled state;

FIG. 14 is a side, cross sectional view of another embodiment of the invention similar to that of FIG. 1 and additionally incorporating a caster for easy ground movement when disengaged, an integrated winch and an improved tongue clamp;

FIG. 15a is a perspective view of the embodiment of FIG. 14; and

FIG. 15b is a side, cross-sectional view of the tongue clamp.

### DETAILED DESCRIPTION OF THE PREFERRED EMBODIMENT

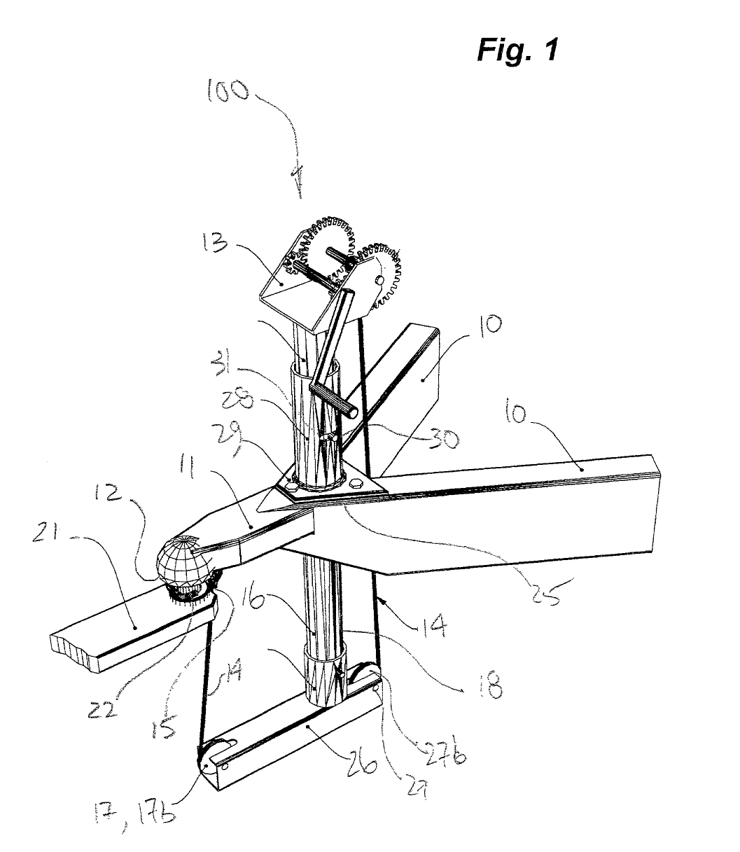

Having reference to FIG. 1, apparatus is provided for coupling towed and towing vehicles. The towed vehicle is described herein as a trailer 10, although this is only one form of towable vehicle. The trailer 10 has a tongue 11 supporting a coupler such as a ball socket 12 which is alternately coupled and decoupled to a hitch 21 having a ball 22. A coupling apparatus 100 is mounted to the trailer 10 and comprises: a winch 13, a flexible cable or line 14 having a distal end 15, a substantially vertical first support member or leg 16, and at least a first roller 17 positioned at a lower end of the leg 16 so as to be lower than the socket 12. Throughout, the term “line” is to be interpreted as any form of tension-capable line such as cable, rope, or strap which can be wound by the winch.

Preferably, the first roller 17 is fitted with a first pulley 17b to enable smooth movement of the cable 14 thereover. The support leg 16 spaces the first roller 17 from the winch 13 and its lower end can also engage the ground so as to serve as a trailer stand 18.

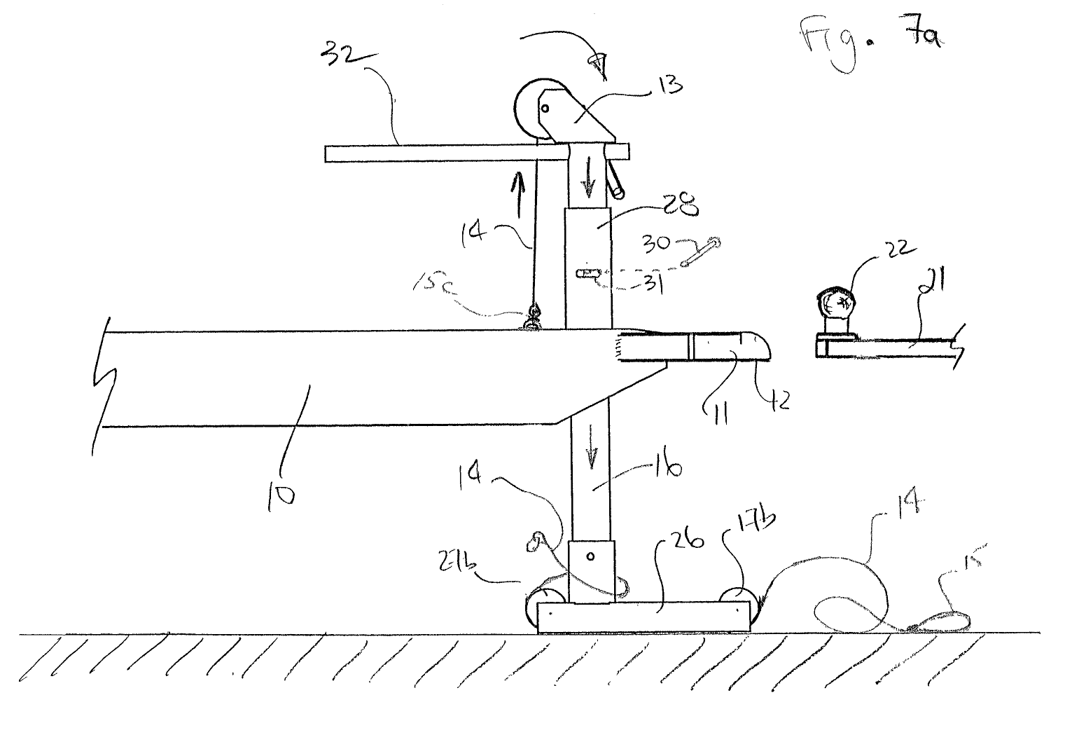

In a first embodiment shown in FIGS. 1-8b, the apparatus or hitch sling 100 serves both as a stand 18 and as an aid in coupling the socket 12 and ball 22.

The hitch sling 100 conveniently adapts to the trailer and can replace expensive and conventional screw type jack stands which are typically secured at the juncture 25 of the tongue 11 and frame of the trailer 10.

A second base member 26 extends forwards from the lower end of the leg 16. The first roller 17 is fitted to the base member at a position substantially beneath the socket 12. The winch 13 is secured to the leg 16 at an upper end. Dependent upon the winch's position and efficacy in routing the line 14 between the winch 13 and first roller 17, the line can be routed over a second roller 27 having a second pulley 27b.

The leg 16 can be adapted for both raised and lowered positions and rotational movement, by forming the leg 16 of cylindrical tubing and fitting the leg 16 through a cylindrical housing or sleeve 28. The sleeve 28 is secured to the trailer 10 by plate 29 mounted at juncture 25. A removable pin 30 passes through both the sleeve 28 and through one of a plurality of corresponding indexing holes formed along the leg 16 so as to lock the leg at one of a plurality of vertical positions. With the pin 30 in place, the leg 16 forms a ground-engaging stand 18 to space or elevate the tongue 11 from the ground.

A circumferentially-extending slot 31 is formed in the sleeve 28 so as to permit the pin 30 to rotate in the slot 31 and permit the leg 16 to rotate relative to the sleeve 28 and trailer 10. Rotation of the leg 16 permits the tongue 11 to be moved side to side to move into and out of alignment with the hitch 21 and ball 22.

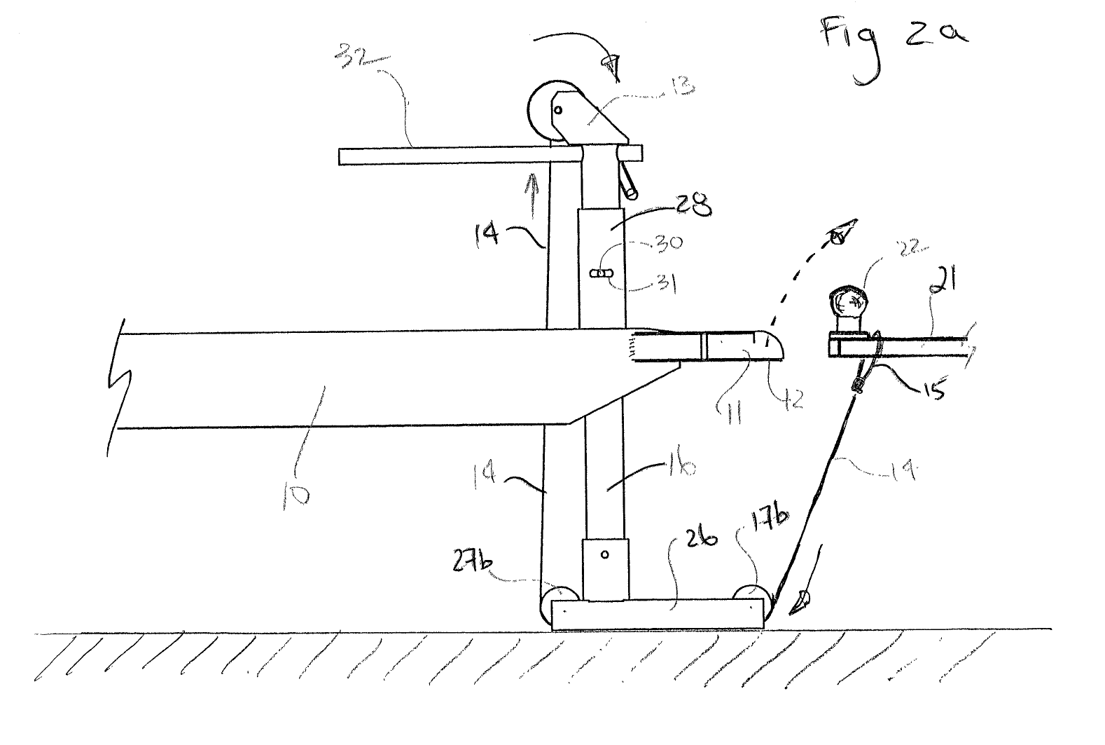

Having reference to FIGS. 2a-4, in operation, the first embodiment is used to couple a socket 12 and ball 22.

First referring to FIGS. 2a,2b, the towing vehicle is backed to within a reasonably coarse proximity (a pace or two) of the trailer tongue 11. The line's distal end 15 is attached to the hitch 21 at or about the ball 22. The winch 13 is actuated to winch in or shorten the line 14, drawing the base member 26 and roller 17 upwardly towards the hitch 21.

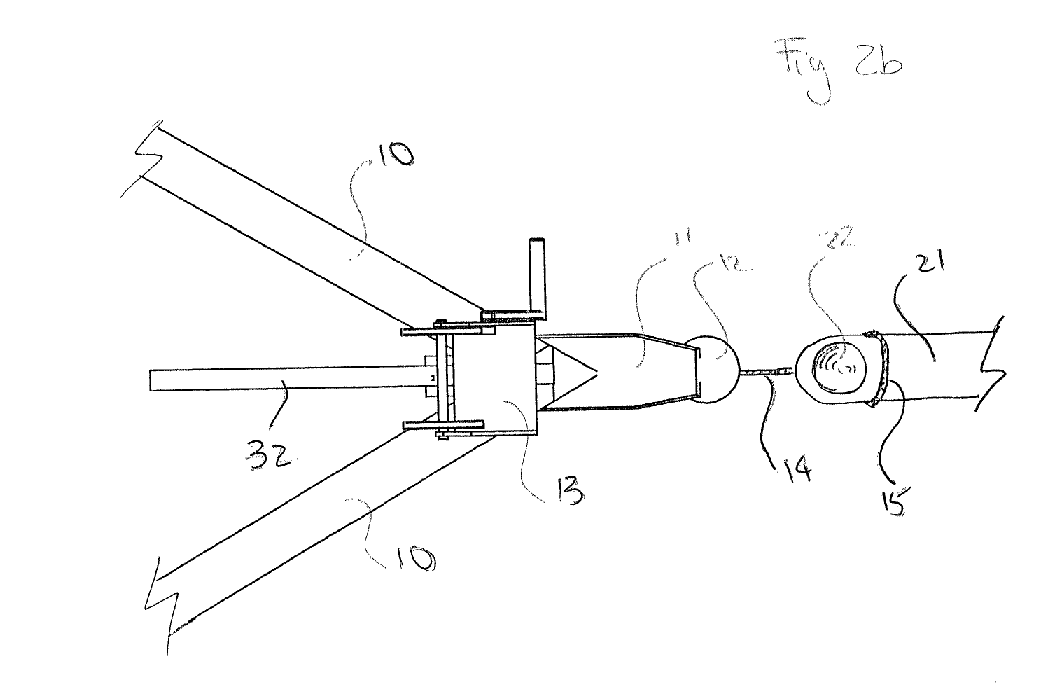

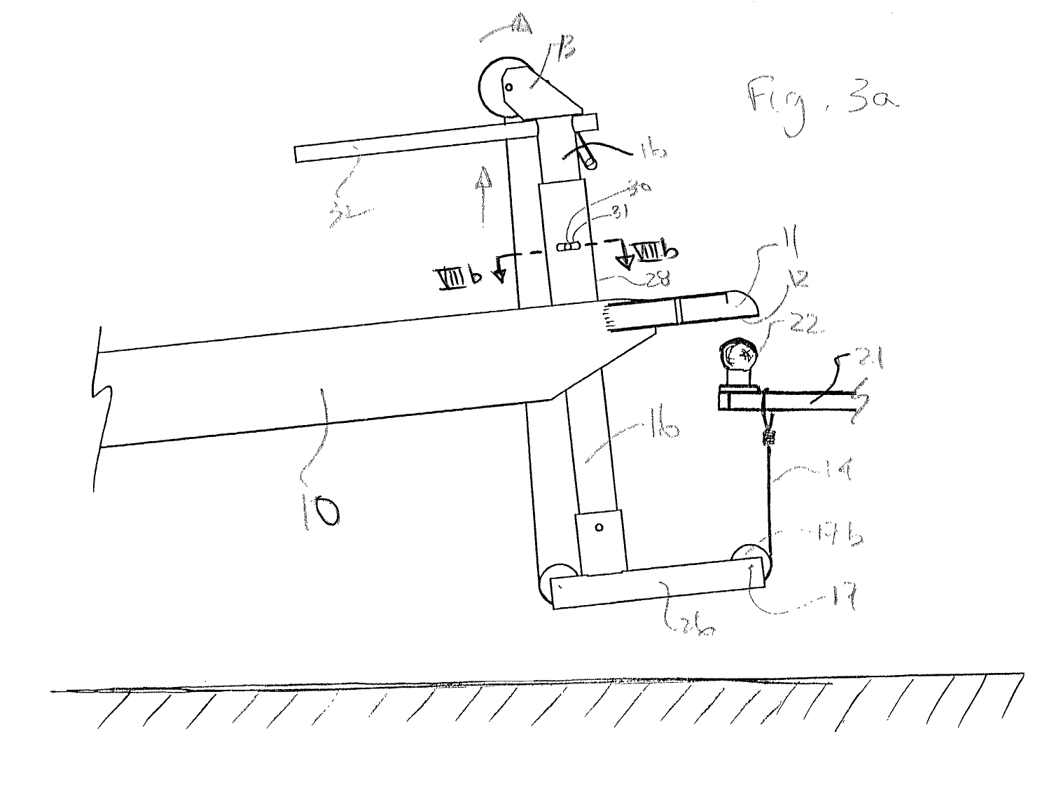

As a result and as shown in FIGS. 3a,3b, the tongue 11 and socket 12 are raised to an elevation above the ball 22.

Turning to FIG. 4, by reversing the winch 13 and releasing or playing out the line 14, the leg 16 and base member 26 are lowered, coupling the socket 12 and ball 22. The line 14 can be left attached about the hitch 21 (as shown) which provides an extra measure of security in addition to safety chains normally required by local law (not shown). The remainder of the coupling process is known in the art and is commonly practiced, such as locking the socket 12 to the ball 22, hooking up safety chains and connecting electrical lines.

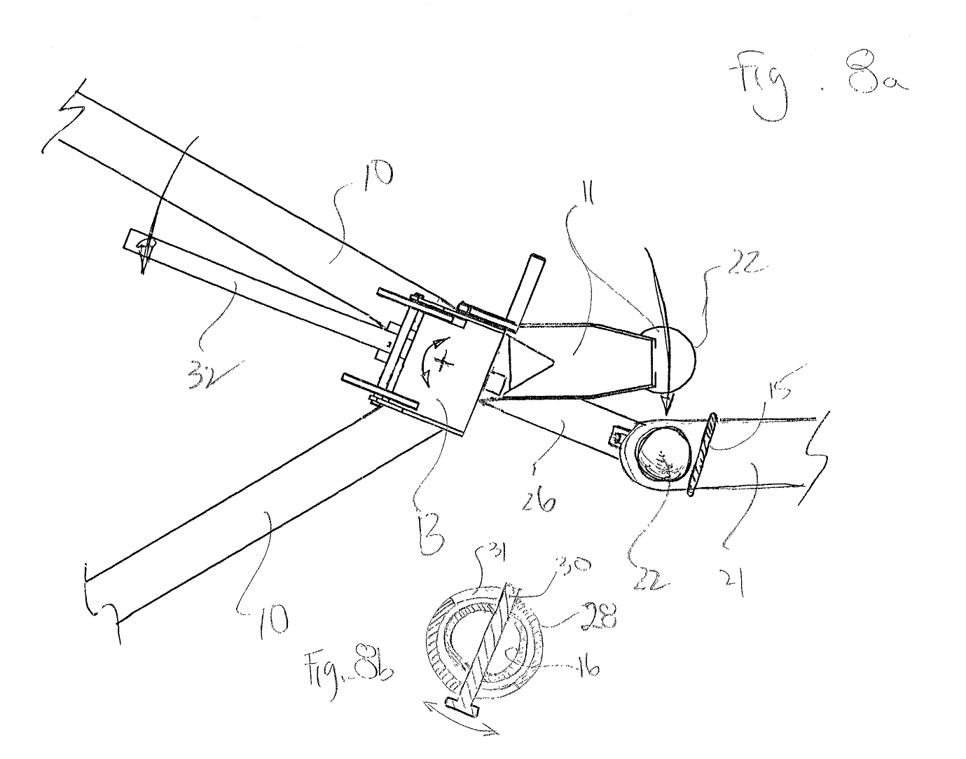

Disengaging or decoupling the trailer 10 from the towing vehicle's hitch 21 is merely a matter of reversing the aforementioned coupling procedure. In brief, the socket 12 and ball 22 are unlocked. The winch 13 is operated to tighten the line 14, lifting the socket 12 from the ball 22 (equivalent to FIG. 3a). The tongue 11 is moved laterally (FIG. 8a) or back (FIG. 2b) while releasing the line 14 to lower the tongue 11 again (back to FIG. 2a).

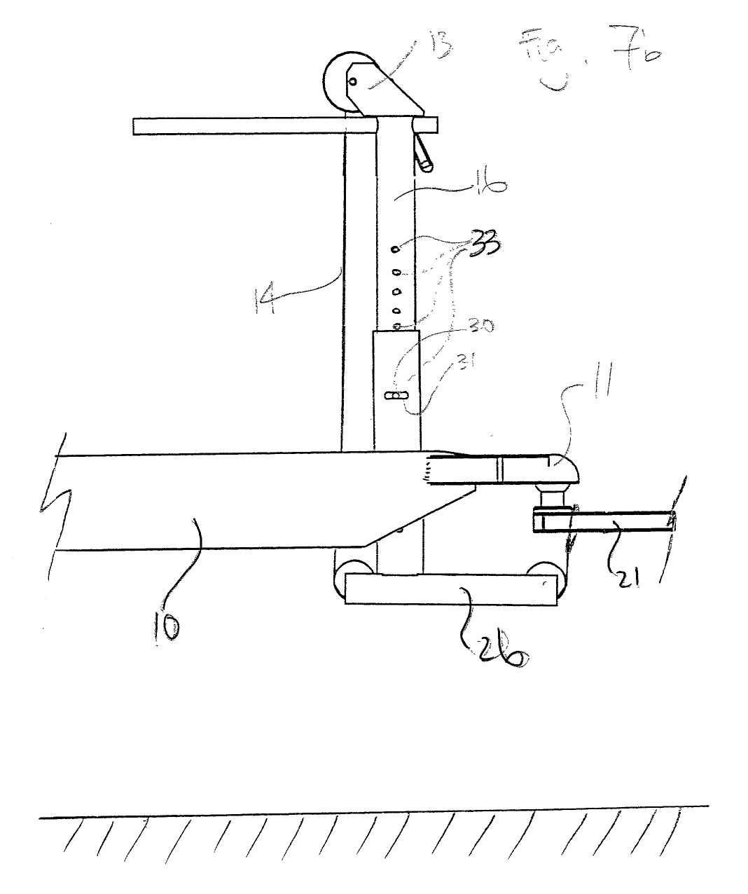

Turning to FIGS. 7a and 7b, in an alternate embodiment, the hitch sling 100 is also designed to replace existing jacks or stands. The leg 16 can be manipulated between at least two positions such as a stand position (FIG. 7a) and a travelling or roading position (FIG. 7b) where the leg 16 is well clear of the ground.

To avoid manually manipulating the full weight of the trailer's tongue, the winch 13 can be used again in a novel manner. The leg 16 and sleeve 28 are temporarily disconnected by removal of the pin 30. As shown in FIG. 7a, to drive the leg 16 downwardly to the ground to act as a stand, the line 14 can be temporarily connected between the winch 13 and the trailer 10. Subsequent winching action drives the winch 13 and leg 16 downwardly to the ground while lifting the trailer 10. Then, as shown in FIG. 7b, for roading, the winch 13 can be employed to raise the base member 26 close to the hitch 21. The line's distal end 15 is secured to the hitch 21 as would be used for coupling the socket 12 and ball 22. With the pin 30 removed however, the socket 12 does not move relative to the ball 22. Instead, the support leg 16 moves up and down through the sleeve 28. A series of indexing holes 33 are located in the leg 16 to provide a variety of elevations to “dolly’ off the trailer 10.

To further aid in minimizing the force necessary to manipulate the tongue 11, the rotational arrangement of the support leg 16 and sleeve 28 are applied in a novel manner.

As shown in FIGS. 8a,8b, and during elevation for coupling or lowering of the tongue 11 after decoupling, the tongue 11 can interfere with hitch 21. If necessary, the operator can apply lateral force to the tongue 11 or trailer 10 to enable the tongue 11 to swing sufficiently on the line 14 to move past the hitch 21. Often the line 14, which extends in tension between the pivot 17 and the hitch 21, provides suitable flexibility to permit the hitch avoidance maneuver. If the line 14 has insufficient flexibility, then as is shown, the support leg 16 can be permitted to rotate slightly within the sleeve 28 to enable a slight side-to-side movement. As shown in FIG. 3a, and 8b, sleeve 28 is fitted with a slot 31, having sufficient radial or circumferential dimension (about 20° of arc) to permit the pin 30 to rotate in the sleeve 28. Leverage for the rotational movement is preferably aided using an alignment lever or handle 32 secured to the leg 16.

While the above embodiments have been described in the context of a recreational trailer, such as a boat trailer and hitch, the hitch sling 100 can also be used for coupling arrangements on implements of husbandry, road construction equipment, material handling equipment, and it has a variety of industrial applications.

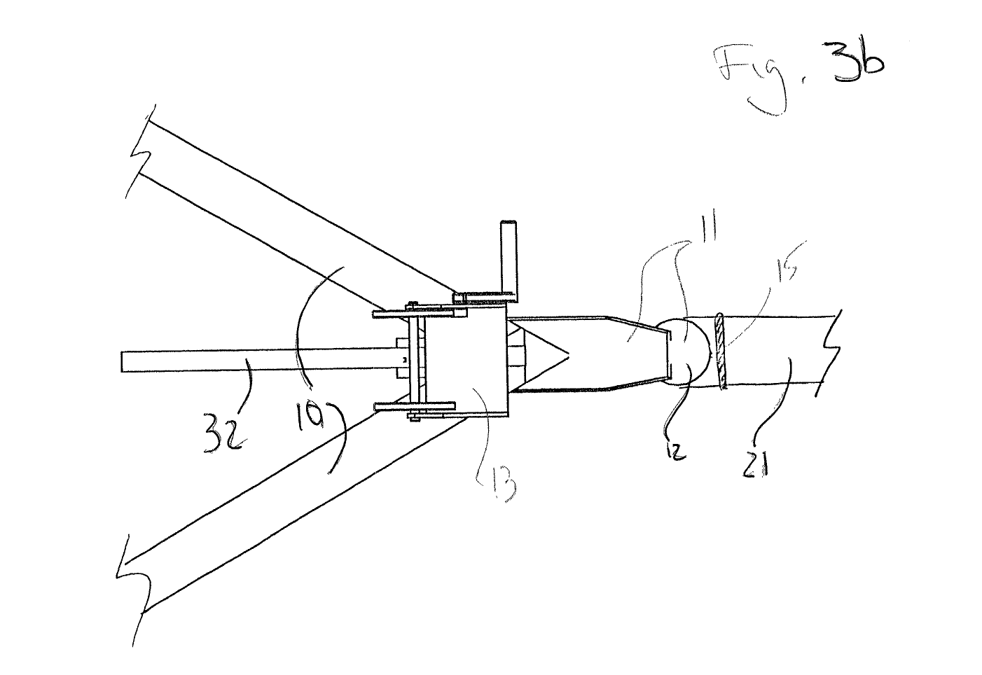

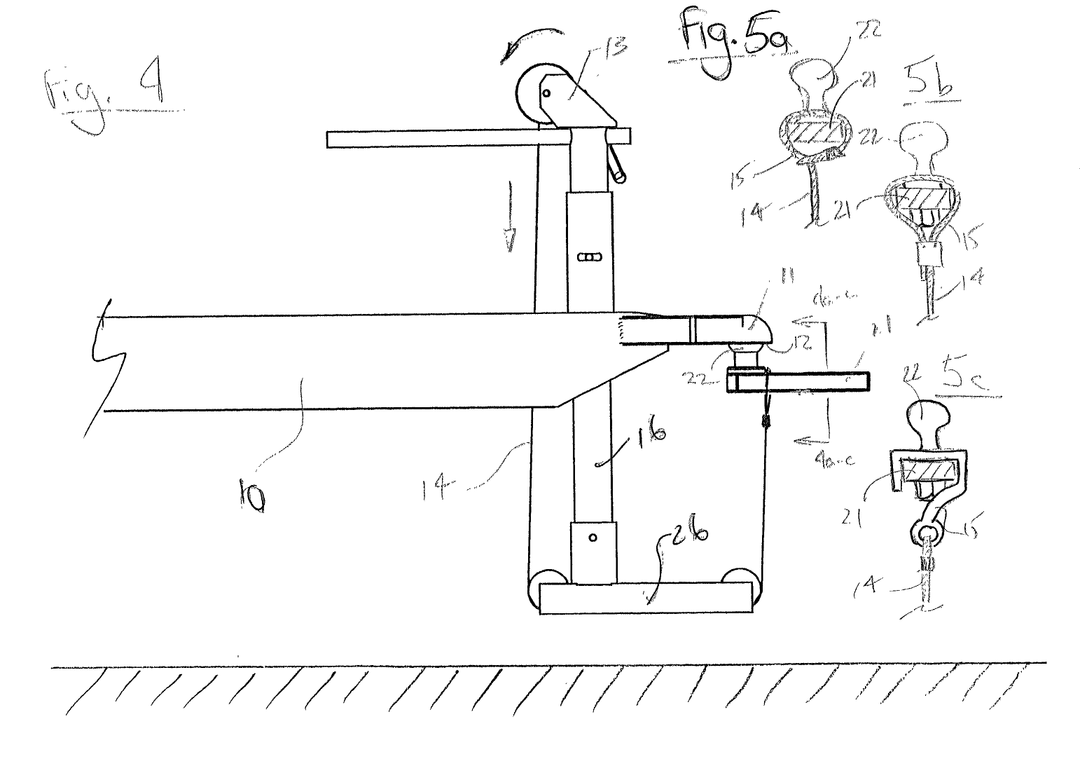

As an example of the embodiment shown in FIGS. 1-8b, a hitch sling 100 was assembled as follows. The support leg 16 was a 3 ft. long piece of small 1.9″ OD tubing fit through a 2″ ID tubing sleeve 28. The sleeve 28 was a short (approx. 10″ long) piece of tubing welded to the mounting plate 29. A winch 13, such as that available from Fulton Performance Products of Wisconsin, was supplied with line 14 formed of 3/16″ aircraft cable. The winch 13 was mounted at the upper end of the support leg 16. A piece of hollow structural tubing formed the base member 26, mounted at the lower end of the support leg 16. Two pulleys 17b,27b were mounted at either end of the base member 26. The line 14 extended approximately 3-6 feet from the winch 13, parallel to the support leg 16, around the second roller 27, through the hollow base member 26 to the first roller 17 and to the distal end 15. As shown in FIGS. 5a-5c, a variety of end configurations or hooks could be used for connecting to the hitch 21 or ball 22.

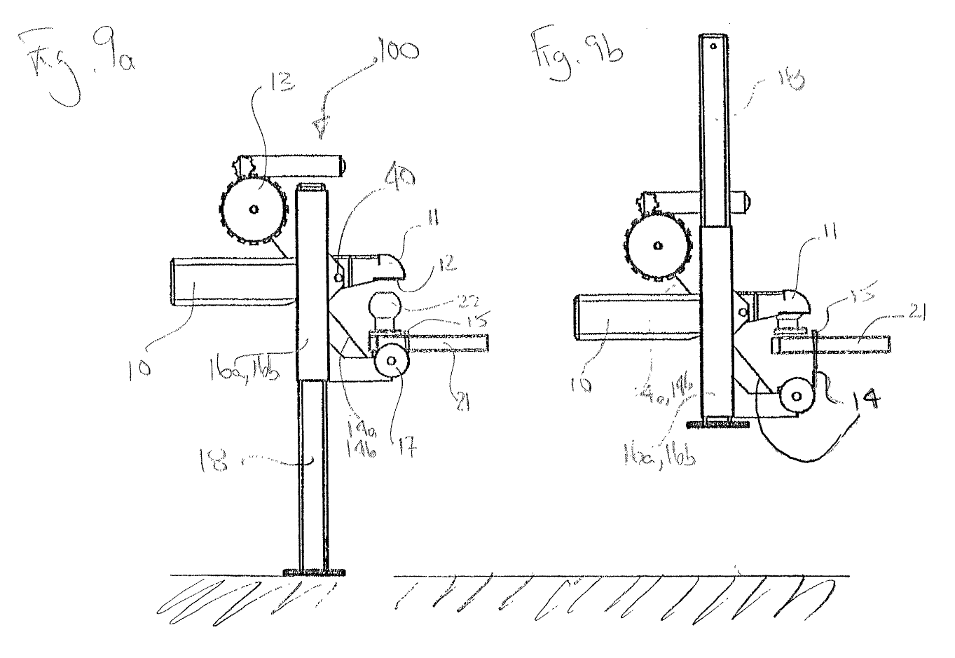

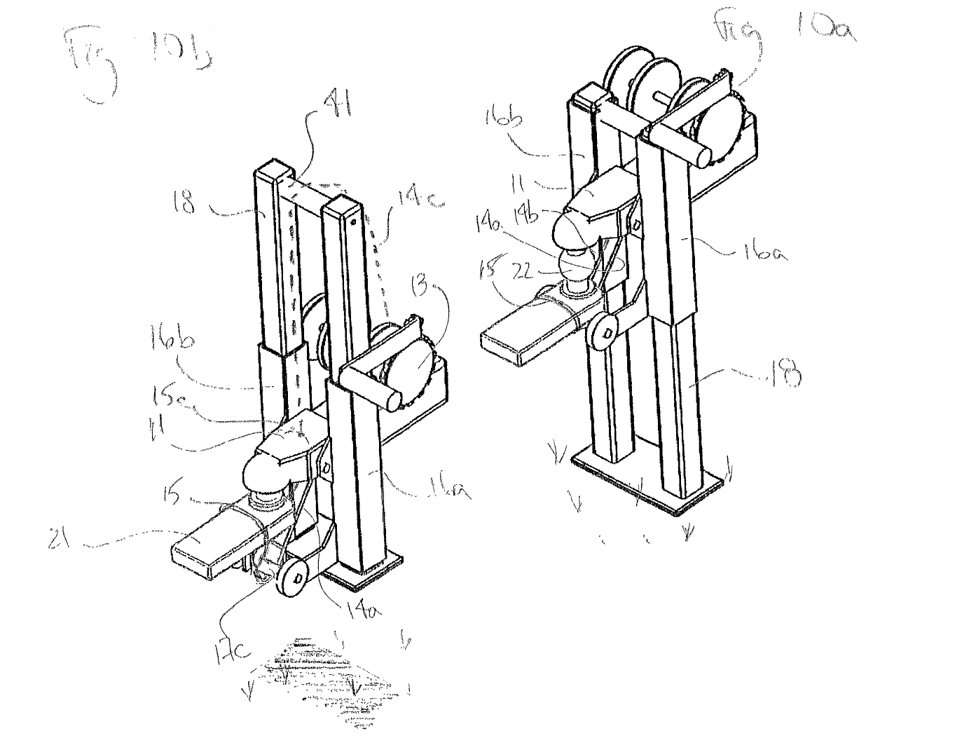

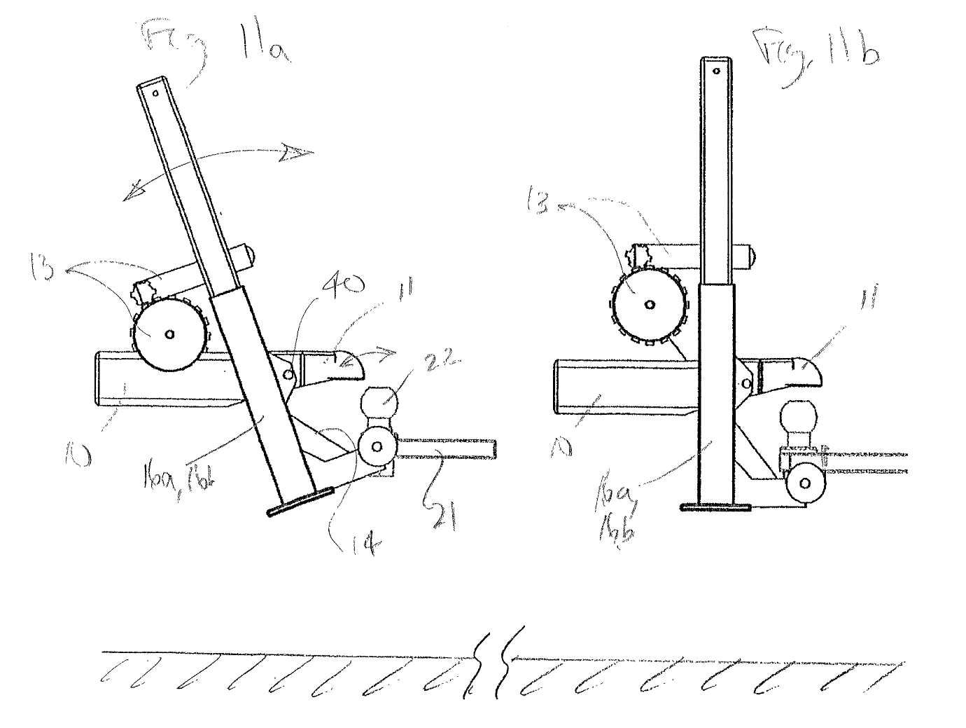

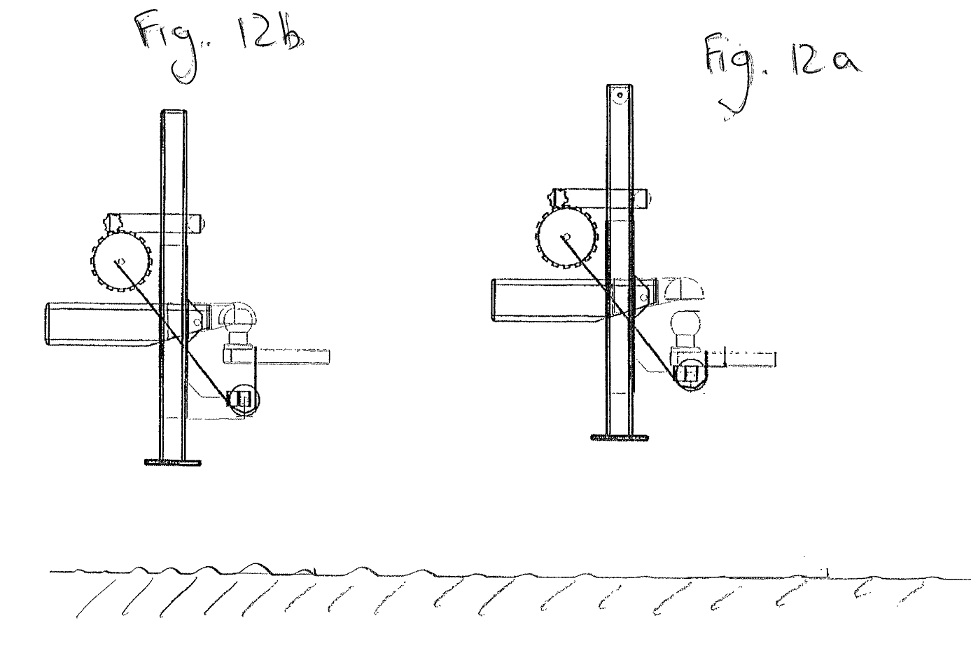

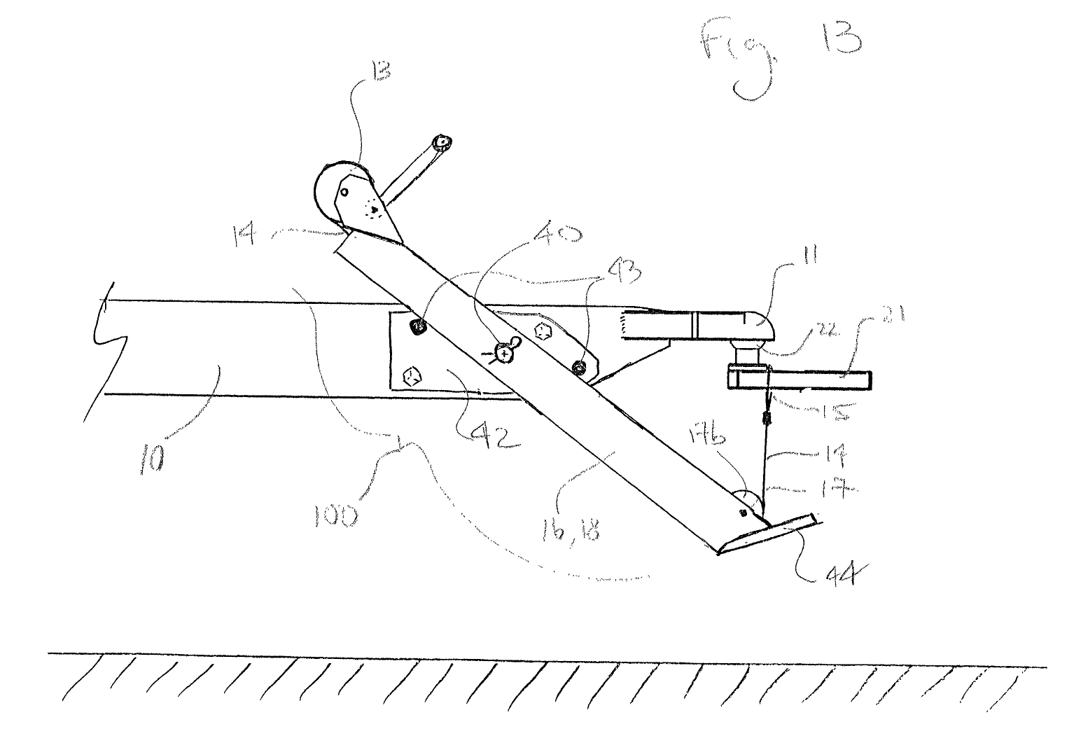

Having reference to FIGS. 9a-12b, another embodiment of the apparatus 100 comprises a pair of support legs 16a,16b, pivotally connected to the tongue 11 at pivot 40. A pair of lines 14a,14b extend directly between the first roller 17 and the winch 13. As shown in FIG. 10b, the first roller is illustrated as a cylindrical roller 17c. Stands 18 extend through support legs 16a,16b and can be unlocked, using a pin and the like (not shown), and raised for road travel. To forcibly drive the stands 18 to the ground and raise the tongue for parking or standing purposes, the line 14 or lines 14a,14b can be slung over an upper roller 41 (shown in dotted lines as 14c) and the distal end 15c is attached to the tongue 11. As the cable 14 is shortened, the pivot 41 and stands 18 are driven downwardly relative to the tongue 11. As shown in FIGS. 11a and 11b, during lifting of the socket 12 to the ball 22, forwards and backwards alignment can be achieved with rotation of the hitch sling apparatus 100 about pivot 40.

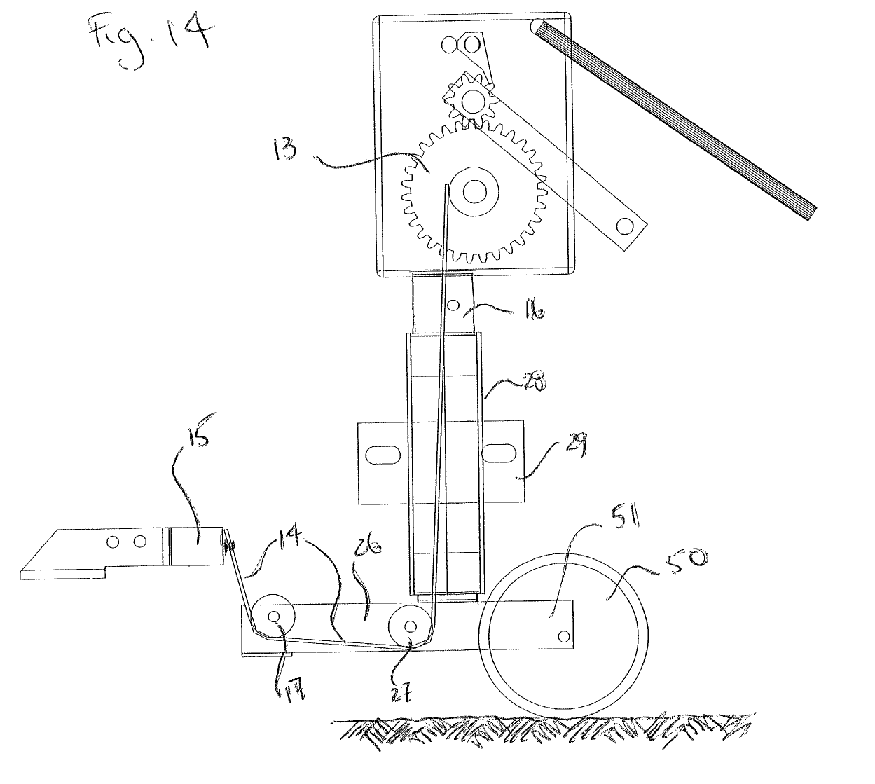

As shown in FIG. 13, a more elementary embodiment comprises a single support leg 16, pivotally attached to the tongue 11 or trailer 10 by a bracket 42. Stops 43 limit rotation of the leg 16 as line 14 is winched in to lift the tongue 11. As shown, only a first roller 17 and pulley 17b are required. The leg 16 acts also as a stand 18, resting on a base 44. During coupling, the leg 16 can be rotated to manipulate the relative positions of the tongue 11 and ball 22, similar to that shown in the embodiment of FIG. 11a.

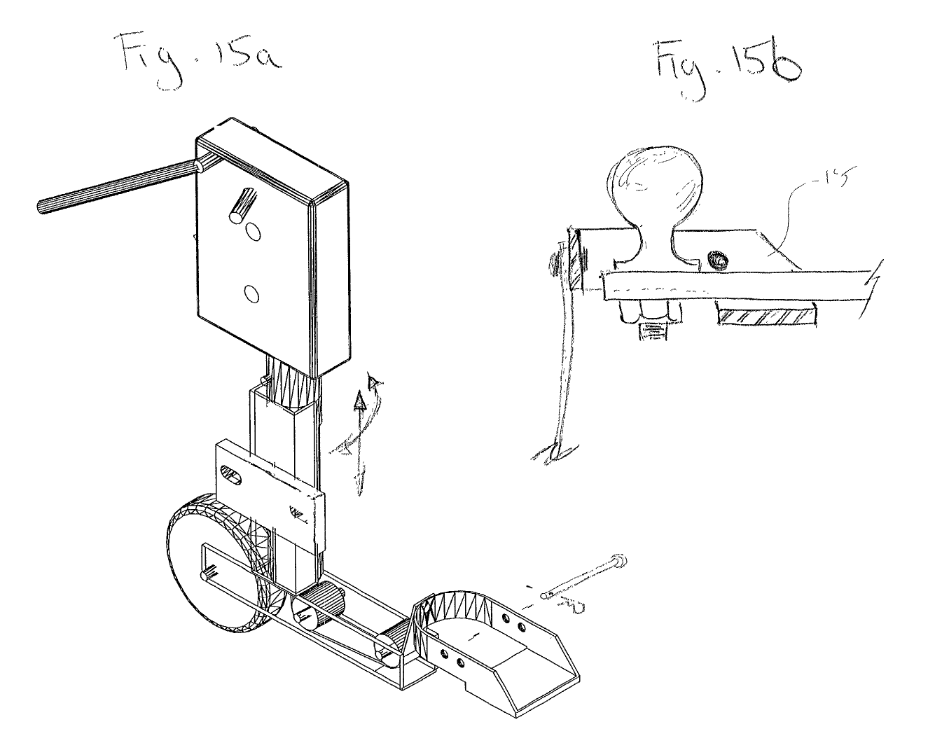

Having reference to yet another embodiment shown in FIGS. 14-15b, a more streamlined arrangement of the embodiment of FIG. 1 is disclosed. This embodiment utilizes nylon or other strong strap material as the winch line 14. The second roller 27 is located aligned with the bore of the leg 16 and the line extends through the bore between the winch 13 and the second roller 27.

As shown in FIG. 14 and 15a, the first roller 17 is located at a first end 49 of the base member 26 and a caster 50 is also provided on the base member 26 at a second end 51 opposing the first end 49. The caster 50 engages the ground when the trailer is disengaged from the tow vehicle. The caster 50 aids in moving the tongue 11 of the trailer when it disengaged from the tow vehicle. Pulling on the cable 14 or trailer tongue 11 causes the leg 16 to pivot in the sleeve 28 and the weight of the tongue 11 to be borne on the caster 50.

Referring to FIG. 15b, a novel distal end 15 is secured to the line 14. The distal end 15 is connected to a “U”-shaped clamp 52 formed with a pair of substantially parallel arms 53 which are spaced for passing the ball 22 and hitch 21. The arms 53 have ends 54 which are connected by a lower plate 55. When the clamp 52 is fitted up and around the ball 22, the lower plate 55 engages the underside of the hitch 21. To secure the clamp 52 to the hitch 21, a pin 56 is inserted through corresponding holes 57 in the arms 53 and located to be freely accessible above the hitch 21 when the lower plate 55 engages the underside of the hitch 21. When tension is applied to the cable 14, the clamp 52 is supported by the pin 56 on the hitch 21 and the moment imposed on the clamp 52 is restrained by the lower plate 55.

The embodiments of the invention for which an exclusive property or privilege is claimed are defined as follows:

1. Apparatus for aiding in coupling a trailer's socket to a ball mounted on a tongue extending from a tow vehicle, the coupling aid comprising:
a support member secured to the trailer so that a lower end is located below the trailer's socket;
a first roller at the support member's lower end and positioned substantially below the trailer's socket;
a winch; and
a flexible line which extends from the winch, about the first roller and to a distal end, so that,
when the distal end is secured to the tongue and the line is winched into the winch, the line passes over the first roller which lifts the support member upwardly towards the tongue so as to position the socket substantially above the ball, and
when the line is winched out of the winch the socket is lowered onto the ball for coupling.

2. The coupling aid of claim 1 wherein the support member is secured to the trailer so as to be rotatable about a substantially vertical axis wherein the position of the first roller can be rotated in an arc beneath the ball for enabling side to side positioning of the socket over the ball.

3. The coupling aid of claim 2 wherein the support member is cylindrical and mounted rotatably in a cylindrical sleeve, the sleeve being secured to the trailer.

4. The coupling aid of claim 3 wherein the support member further comprises a base member extending from the lower end of the support member and wherein the first roller is located adjacent a first end of the base member.

5. The coupling aid of claim 4 wherein the lower end of the support member can be axially repositioned in the sleeve between at least two positions comprising a first low position for forming a stand, and a second high position.

6. The coupling aid of claim 5 wherein the winch is positioned adjacent an upper end of the support member, the aid further comprising a second roller located adjacent the support member's lower end wherein the line extends from the distal end, around the first roller, around the second roller and up to the winch.

7. The coupling aid of claim 6 wherein the support member has a bore and the second roller is aligned with the support member's bore so that the line extends through the support member's bore between the winch and the second pivot.

8. The coupling aid of claim 4 wherein the support member has two or more indexing holes formed at incremental vertical locations in the support members and the sleeve is fitted with a least one corresponding hole, further comprising a pin for passing through the sleeve's hole and through one of the two or more indexing holes for determining the vertical position of the support member.

9. The coupling aid of claim 8 wherein the sleeve's hole is slotted circumferentially so that the support member and pin can be rotated in an arc.

10. The coupling aid of claim 4 wherein the base member further comprises a ground-engaging caster.

11. The coupling aid of claim 10 wherein the first roller is located at the first end of the base member and the castor is located at a second end of the base member, the base member being mounted to the lower end of the support member at a point intermediate the base member's first and second ends.
